(19) United States
(12) Patent Application Publication
(10) Pub. No.: US 2026/0169970 A1
(43) Pub. Date: Jun. 18, 2026

(54) ORCHESTRATION OF INDEX CREATION IN DISTRIBUTED SYSTEMS

(71) Applicant: Dell Products L.P., Round Rock, TX (US)

(72) Inventors: Sriram Subramanian, Bangalore (IN); Dhilip S. Kumar, Bangalore (IN); Yuvaraj Muthusamy, Bangalore (IN); M Eshwar Rao, Hyderabad (IN)

(21) Appl. No.: 18/986,090

(22) Filed: Dec. 18, 2024

(51) Int. Cl. G06F 16/22; G06F 11/34; G06F 16/27

(52) U.S. Cl. CPC G06F 16/2272; G06F 11/3433; G06F 11/3495; G06F 16/27

(57) ABSTRACT

An apparatus comprises at least one processing device configured to monitor one or more distributed systems to determine index data associated with usage of indexes in the distributed systems and performance data associated with the distributed systems. The at least one processing device is also configured to determine, utilizing a first machine learning model that takes as input at least a portion of a first data structure characterizing the index data, at least one additional index to be created, and to determine, utilizing a second machine learning model that takes as input at least a portion of a second data structure characterizing the performance data, a load factor threshold. The at least one processing device is further configured to control creation of the additional index in the distributed systems based at least in part on determining whether a current workload of the distributed systems exceeds the determined load factor threshold.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Information processing systems may include distributed systems, which include distributed computing systems with components on multiple networked information computers that communicate with one another to perform one or more tasks, such as data sharing. Examples of distributed systems include, but are not limited to, distributed databases, systems which store geographically-distributed data sets, an IT infrastructure implementing data sharing across IT assets, etc. Distributed systems may maintain one or more indexes supporting efficient querying and information retrieval.

### SUMMARY

Illustrative embodiments of the present disclosure provide techniques for orchestration of index creation in distributed systems.

In one embodiment, an apparatus comprises at least one processing device comprising a processor coupled to a memory. The at least one processing device is configured to monitor one or more distributed systems to determine (i) index data associated with usage of one or more indexes in the one or more distributed systems and (ii) performance data associated with the one or more distributed systems. The at least one processing device is also configured to determine, utilizing a first machine learning model that takes as input at least a portion of a first data structure characterizing the index data associated with the usage of the one or more indexes in the one or more distributed systems, at least one additional index to be created in the one or more distributed systems. The at least one processing device is further configured to determine, utilizing a second machine learning model that takes as input at least a portion of a second data structure characterizing the performance data associated with the one or more distributed systems, a load factor threshold for the one or more distributed systems. The at least one processing device is further configured to control creation of the at least one additional index in the one or more distributed systems based at least in part on determining whether a current workload of the one or more distributed systems exceeds the determined load factor threshold for the one or more distributed systems.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for orchestration of index creation in distributed systems in an illustrative embodiment.

FIG. 2 is a flow diagram of an exemplary process for orchestration of index creation in distributed systems in an illustrative embodiment.

FIG. 3 shows a system implementing an autonomous index lifecycle management framework for index management in distributed systems in an illustrative embodiment.

FIG. 4 shows a process flow process flow for index management in a distributed system in an illustrative embodiment.

FIG. 5 shows an autonomous index lifecycle management system configured for management of indexes used in distributed systems in an illustrative embodiment.

FIG. 6 shows a process flow for autonomous index lifecycle management in an illustrative embodiment.

FIG. 7 shows an example of collected index statistics in an illustrative embodiment.

FIG. 8 shows pseudocode for collecting index statistics in an illustrative embodiment.

FIG. 9 shows pseudocode for loading index data and a table of loaded index data in an illustrative embodiment.

FIG. 10 shows pseudocode for training a random forest regression model in an illustrative embodiment.

FIG. 11 shows pseudocode for generating a predicted index size using a trained random forest regression model and for evaluating the trained random forest regression model in an illustrative embodiment.

FIG. 12 shows pseudocode for initializing machine learning libraries for model training and validation and a table of database metrics in an illustrative embodiment.

FIG. 13 shows pseudocode for creating and training a Long Short Term Memory autoencoder model in an illustrative embodiment.

FIG. 14 shows a plot of the distribution of the loss function for a Long Short Term Memory autoencoder model in an illustrative embodiment.

FIG. 15 shows pseudocode for testing a Long Short Term Memory autoencoder model using database metrics above a load factor threshold value in an illustrative embodiment.

FIG. 16 shows a plot of the mean absolute error and load factor threshold in an illustrative embodiment.

FIG. 17 shows another process flow for autonomous index lifecycle management in an illustrative embodiment.

FIGS. 18 and 19 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

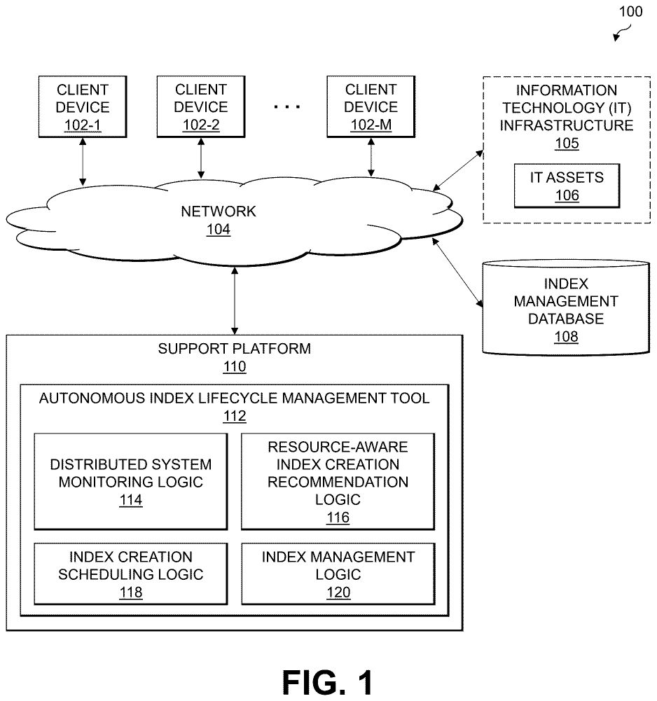

FIG. 1 shows an information processing system 100 configured in accordance with an illustrative embodiment. The information processing system 100 is assumed to be built on at least one processing platform and provides functionality for orchestration of index creation in distributed systems. As used herein, the term “distributed system” refers to a distributed computing system with components on multiple networked information technology (IT) assets (e.g., computers, nodes, etc.) that communicate with another (e.g., to perform one or more tasks, such as data sharing). Examples of distributed systems include, but are not limited to, distributed databases, systems which store geographically-distributed data sets, an IT infrastructure implementing data sharing across IT assets, etc. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, an index management database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for index management (e.g., for creation and validation of indexes created in one or more database services or servers of one or more distributed systems implemented utilizing the IT assets 106 of the IT infrastructure 105). The index management may include determining whether to create new indexes (e.g., based on query patterns for queries submitted by the client devices 102 to one or more databases or other data stores of one or more distributed systems implemented utilizing the IT assets 106 of the IT infrastructure 105) and when to start, pause and resume index creation processes (e.g., based on monitoring the workload or performance of the one or more distributed systems implemented utilizing the IT assets 106 of the IT infrastructure 105). Index management may also include validation of created indexes, and determining when to remove unused or underutilized indexes. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The index management database 108 is configured to store and record various information that is utilized by the support platform 110. Such information may include, for example, information related to existing indexes which are maintained and utilized in one or more distributed systems (e.g., which are implemented utilizing the IT assets 106 of the IT infrastructure 105), index creation scripts (e.g., for initiating and running index creation jobs), performance data for the distributed systems, index creation jobs, machine learning models which are used in index management processes, etc. The index management database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform index management (e.g., for one or more distributed systems, including distributed databases, implemented utilizing the IT assets 106 of the IT infrastructure 105). In some embodiments, the client devices 102 are assumed to be associated with system administrators, IT managers or other authorized personnel responsible for index management for an enterprise, organization or other entity. In some embodiments, the client devices 102 are utilized by members of the same enterprise, organization or other entity that operates the support platform 110. In other embodiments, the client devices 102 are utilized by members of one or more enterprises, organizations or other entities different than the enterprise, organization or other entity that operates the support platform 110 (e.g., a first enterprise provides index management support functionality for multiple different customers, businesses, etc.). Various other examples are possible.

In some embodiments, the client devices 102 and/or the IT assets 106 of the IT infrastructure 105 may implement host agents that are configured for automated transmission of information with the index management database 108 and the support platform 110 regarding index management operations (e.g., performance data, index creation jobs, index usage data, etc.). It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements an autonomous index lifecycle management tool 112. The autonomous index lifecycle management tool 112 comprises distributed system monitoring logic 114, resource-aware index creation recommendation logic 116, index creation scheduling logic 118, and index management logic 120. The distributed system monitoring logic 114 is configured to monitor one or more distributed systems (e.g., implemented utilizing the IT assets 106 of the IT infrastructure 105) to determine real-time index data (e.g., characterizing existing indexes utilized in the distributed systems, query patterns in the distributed systems, index usage in the distributed systems, etc.) as well as performance data for the distributed systems. Such information is utilized by the resource-aware index creation recommendation logic 116 to recommend new indexes to be created in the distributed systems. The resource-aware index creation recommendation logic 116 may utilize one or more artificial intelligence (AI) and machine learning (ML) models to provide such recommendations, including predicting the size of indexes to be created. Such AI/ML models may include a Random Forest regression model. The index creation scheduling logic 118 is configured to receive the index creation recommendations from the resource-aware index creation recommendation logic 116, as well as performance data for the distributed systems from the distributed system monitoring logic 114, and uses such information to determine whether and when to start, pause and resume index creation operations in the distributed systems. The index management logic 120 is configured to utilize the real-time index data collected from the distributed system monitoring logic 114 to monitor index usage, and to determine whether and when to remove indexes from the distributed systems (e.g., to remove unused or underutilized indexes).

At least portions of the autonomous index lifecycle management tool 112, the distributed system monitoring logic 114, the resource-aware index creation recommendation logic 116, the index creation scheduling logic 118 and the index management logic 120 may be implemented at least in part in the form of software that is stored in memory and executed by a processor.

It is to be appreciated that the particular arrangement of the client devices 102, the IT infrastructure 105, the index management database 108 and the support platform 110 illustrated in the FIG. 1 embodiment is presented by way of example only, and alternative arrangements can be used in other embodiments. As discussed above, for example, the support platform 110 (or portions of components thereof, such as one or more of the autonomous index lifecycle management tool 112, the distributed system monitoring logic 114, the resource-aware index creation recommendation logic 116, the index creation scheduling logic 118 and the index management logic 120) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the index management database 108 and the support platform 110 or components thereof (e.g., the autonomous index lifecycle management tool 112, the distributed system monitoring logic 114, the resource-aware index creation recommendation logic 116, the index creation scheduling logic 118 and the index management logic 120) may be implemented on respective distinct processing platforms, although numerous other arrangements are possible. For example, in some embodiments at least portions of the support platform 110 and one or more of the client devices 102, the IT infrastructure 105, the IT assets 106 and/or the index management database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the index management database 108 and the support platform 110, or portions or components thereof, to reside in different data centers. Numerous other distributed implementations are possible. The support platform 110 can also be implemented in a distributed manner across multiple data centers.

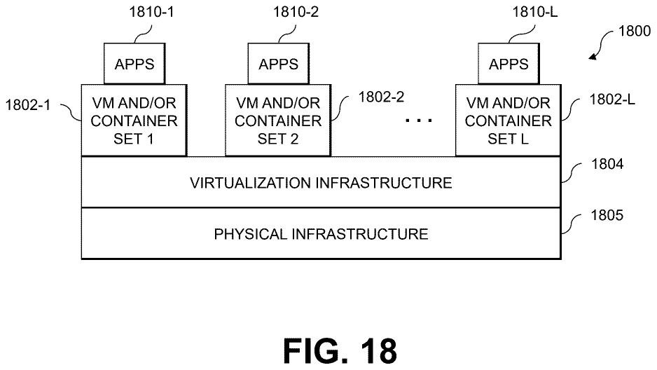

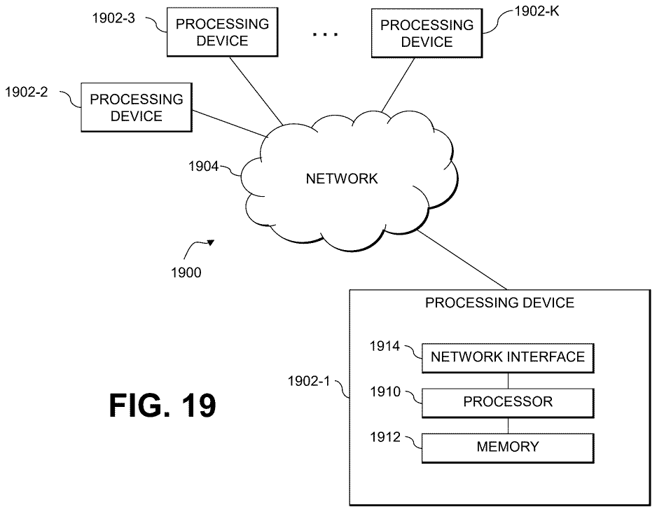

Additional examples of processing platforms utilized to implement the support platform 110 and other components of the information processing system 100 in illustrative embodiments will be described in more detail below in conjunction with FIGS. 18 and 19.

It is to be understood that the particular set of elements shown in FIG. 1 for orchestration of index creation in distributed systems is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

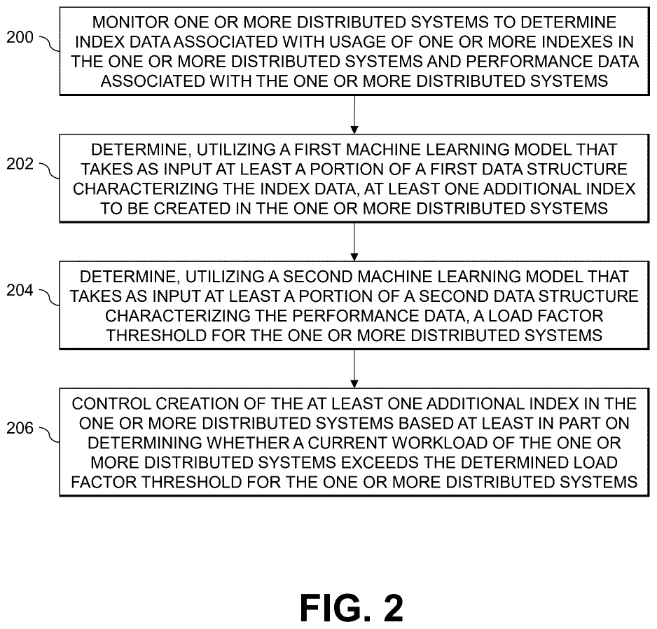

An exemplary process for orchestration of index creation in distributed systems will now be described in more detail with reference to the flow diagram of FIG. 2. It is to be understood that this particular process is only an example, and that additional or alternative processes for orchestration of index creation in distributed systems may be used in other embodiments.

In this embodiment, the process includes steps 200 through 206. These steps are assumed to be performed by the support platform 110 utilizing the autonomous index lifecycle management tool 112, the distributed system monitoring logic 114, the resource-aware index creation recommendation logic 116, the index creation scheduling logic 118 and the index management logic 120. The process begins with step 200, monitoring one or more distributed systems to determine (i) index data associated with usage of one or more indexes in the one or more distributed systems and (ii) performance data associated with the one or more distributed systems. The one or more distributed systems may comprise a distributed database system, one or more geographically-dispersed datasets including at least a first portion of data in a first geographic location and a second portion of data in a second geographic location, an IT infrastructure implementing data sharing across a plurality of IT assets, etc.

In step 202, at least one additional index to be created in the one or more distributed systems is determined utilizing a first machine learning model that takes as input at least a portion of a first data structure characterizing the index data associated with the usage of the one or more indexes in the one or more distributed systems. The first machine learning model may comprise a Random Forest regression model. The index data associated with the usage of the one or more indexes in the one or more distributed systems may comprise information characterizing: one or more existing indexes utilized in the one or more distributed systems; query patterns for queries in the one or more distributed systems; and usage of the one or more existing indexes by the queries in the one or more distributed systems.

In step 204, a load factor threshold for the one or more distributed systems is determined utilizing a second machine learning model that takes as input at least a portion of a second data structure characterizing the performance data associated with the one or more distributed systems. The second machine learning model may comprise a Long Short Term Memory (LSTM) Autoencoder. Determining the load factor threshold for the one or more distributed systems may comprise: utilizing the second machine learning model to determine a loss distribution for a portion of the performance data characterizing normal operation of the one or more distributed systems; and selecting the load factor threshold based at least in part on the determined loss distribution for the portion of the performance data characterizing the normal operation of the one or more distributed systems.

In step 206, creation of the at least one additional index in the one or more distributed systems is controlled based at least in part on determining whether a current workload of the one or more distributed systems exceeds the determined load factor threshold for the one or more distributed systems. Controlling the creation of the at least one additional index in the one or more distributed systems may comprise: initiating, responsive to detecting that the one or more distributed systems have sufficient available resources according to the determined load factor threshold, an index creation job in the one or more distributed systems to create the at least one additional index; pausing the index creation job responsive to detecting that the index creation job is currently running and that the one or more distributed systems do not have sufficient available resources according to the determined load factor threshold; and resuming the index creation job responsive to detecting that the index creation job is paused and the one or more distributed systems have sufficient available resources according to the determined load factor threshold.

In some embodiments, determining the at least one additional index to be created in the one or more distributed systems further comprises predicting a size of the at least one additional index to be created in the one or more distributed systems. Controlling the creation of the at least one additional index in the one or more distributed systems may be further based at least in part on the predicted size of the at least one additional index. The FIG. 2 process may further include, responsive to determining that the creation of the at least one additional index in the one or more distributed systems is completed, validating the created at least one additional index based at least in part on comparing a size of the created at least one additional index to the predicted size of the at least one additional index.

In some embodiments, determining the at least one additional index to be created in the one or more distributed systems further comprises generating an index creation script for initiating creation of the at least one additional index in the one or more distributed systems, and controlling the creation of the at least one additional index in the one or more distributed systems may comprise initiating an index creation job in the one or more distributed systems utilizing the generated index creation script.

The FIG. 2 process may further include, responsive to determining that the creation of the at least one additional index in the one or more distributed systems is completed: monitoring usage of the created at least one additional index in the one or more distributed systems; and determining whether to retain the created at least one additional index in the one or more distributed systems based at least in part on the monitored usage of the created at least one additional index.

It should be noted that the term “data structure” as used herein is intended to be broadly construed. A data structure, such as any single one of or combination of the first and second data structures referred to above, may provide a portion of a larger data structure, or any one of or combination of the first and second data structures may be combinations of multiple smaller data structures. Therefore, the first and second data structures referred to above may be different parts of a same overall data structure, or one or more of the first and second data structures could be made up of multiple smaller data structures. The data structures may include tables, vectors, embeddings, or various other data structures. In some embodiments, the data structures are specifically formatted or generated such that they are suitable for use as at least one of an input to and an output from a machine learning model. It should further be appreciated that “generating” a data structure may encompass, for example, populating an existing or previously-created data structure with one or more data items.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Managing indexes (e.g., database indexes) across distributed systems, particularly within data exchanges, data broker environments and for geographically distributed datasets, presents significant challenges. Heterogeneous indexing strategies, real-time updates, and varying query patterns across multiple systems complicate index management. Ensuring data quality, consistency, and security while optimizing index performance and cost-efficiency is crucial. Indexes are fundamental for efficient data retrieval and query performance in data exchange ecosystems. Indexes enable faster data access, improved query responsiveness, and better support for data analysis and exploration. By optimizing index management, organizations can unlock the full potential of their data assets and drive informed decision-making. To effectively support data exchange, data brokers and data marketplaces, robust index management strategies must address issues such as index heterogeneity, maintenance, optimization and security. The non-relational data paradigm of distributed systems stores data in documents, graphs, columns and key-value pairs. Complex joins or aggregations and their dynamic data models and tool-generated queries introduce a major obstacle—the inefficiency and limitations of manual index management.

In distributed systems, secondary indexes (e.g., allowing for searching in a database using information other than the primary keys) can be constructed to filter or categorize data based on specific attributes. These secondary indexes can support various search functionalities, including geospatial, textual and multilingual queries. Unlike traditional relational databases, where index types are predefined, distributed data systems often require manual index creation and management. This manual process can be time-consuming and error-prone, impacting query performance and system efficiency. Such traditional or conventional approaches require significant manual effort for analyzing resource needs, assessing query impacts, and creating and validating indexes. Frequent feature changes further exacerbate these issues, rendering indexes obsolete more often. Moreover, manual index creation in large systems can lead to disruptive downtime or off-hours deployments, while also carrying the risk of overloading or crashing of database systems.

To address these and other technical challenges, illustrative embodiment provide technical solutions for intelligent and autonomous index lifecycle management. The technical solutions are able to intelligently manage the entire index lifecycle, encompassing identification of necessary indexes, resource allocation optimization, index creation, index validation and index maintenance. This comprehensive approach provides significant technical improvements, including through improving developer productivity by eliminating manual tasks, reducing operational costs by optimizing resource utilization, and enhancing overall system efficiency by ensuring that indexes are up-to-date and optimized for query performance.

The technical solutions advantageously align with a data management domain and sub-domains. Data management is the practice of collecting, securing, analyzing and storing an organization's data to drive decision-making (e.g., business decisions). An organization may have an expansive infrastructure, including many distributed data systems, which presents unique challenges in managing indexes efficiently. Given the administrative nature of index management and its reliance on real-time monitoring data, integrating index management tools directly into distributed systems is impractical. The technical solutions described herein provide an autonomous index lifecycle management framework or system including a resource-aware indexer and an autonomous index orchestrator, where the autonomous index lifecycle management framework or system acts as an intermediary between monitoring tools and distributed data systems, autonomously addressing index-related issues and providing a novel solution that addresses critical gaps in conventional approaches. By integrating the autonomous index lifecycle management system into an organization's existing infrastructure, and leveraging telemetry tools (e.g., Moogsoft), the technical solutions described herein are able to effectively monitor and optimize index performance across the entire distributed data system landscape. This is expected to yield significant operational efficiencies, including reduced engineer hours, incident tickets, and costs. The technical solutions described herein, in addition to addressing the complexity of managing a large-scale distributed data environment, also align with organizations committed to leveraging artificial intelligence (AI) and optimizing IT operations.

The technical solutions described herein can provide various technical advantages, including: uninterrupted operation of distributed systems and other IT infrastructure through eliminating the need for disruptive downtime or off-hours deployments, ensuring continuous application availability and user experience; enhanced productivity through improving developer and engineer productivity, optimizing resource utilization and enhancing overall system stability and performance, ultimately leading to a more efficient and scalable environment that ensures business continuity; optimized resource utilization through intelligent allocation of resources based on actual needs, preventing resource waste and improving overall system efficiency, which provides cost optimization through resource optimization; improved system stability through proactive index management and crash prevention during index creation processes, contributing to a more stable and reliable distribute system environment facilitating the efficient operation of a business or other organization; and enabling dynamic indexing in storage infrastructure, paving the way for the exploration of dynamic indexing techniques within the storage infrastructure itself, further enhancing storage performance and scalability. While existing monitoring tools may identify indexes, such monitoring tools lack autonomous index lifecycle management capabilities. Thus, the technical solutions described herein address a critical gap in distributed data system optimization.

The technical solutions described herein address various technical challenges associated with manual index management in distributed data systems, including within data exchanges, data broker environments, and for geographically-distributed datasets. These environments often face dynamic data models, evolving query patterns, and the complexities of managing indexes across multiple systems. The technical solutions described herein provide an autonomous index management solution that streamlines the entire index lifecycle, from identification and creation to optimization and maintenance.

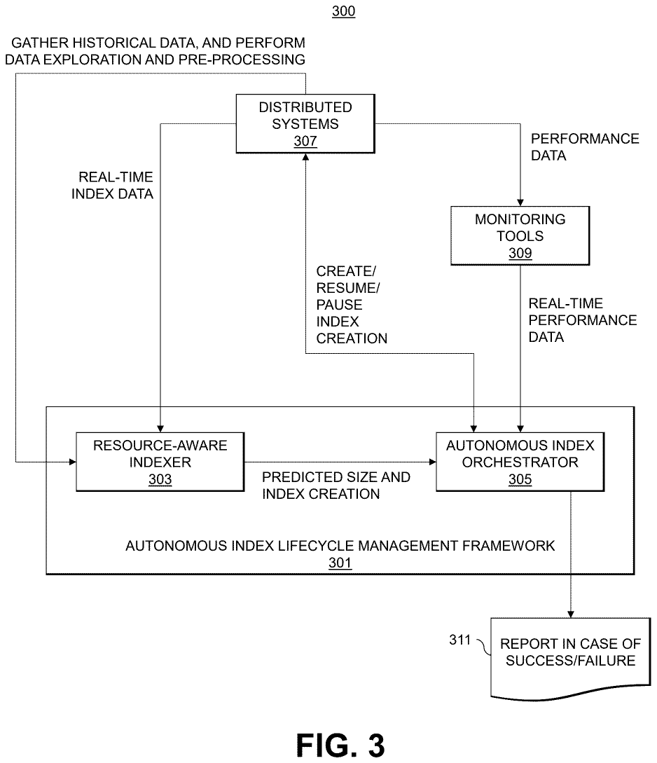

FIG. 3 shows a system 300 implementing an autonomous index lifecycle management framework 301, including a resource-aware indexer 303 and an autonomous index orchestrator 305. The system 300 also includes one or more distributed systems 307 and one or more monitoring tools 309. The resource-aware indexer 303 is configured to analyze metadata to predict resource requirements accurately utilizing a machine learning (ML) model (e.g., a Random Forest regression model). The autonomous index orchestrator 305 is configured to manage the index lifecycle autonomously, leveraging a ML model (e.g., a Long Short Term Memory (LSTM) Autoencoder) for intelligent decision-making.

The resource-aware indexer 303 is configured to gather historical data from the distributed systems 307, and to perform data exploration and pre-processing. The resource-aware indexer 303 is also configured to obtain real-time index data from the distributed systems 307. The resource-aware indexer 303 is configured to utilize a metadata inventory to identify potential correlations between relevant factors using Random Forest regression. The resource-aware indexer 303 provides a predicted size of an index to be created and index creation information to the autonomous index orchestrator 305.

The monitoring tools 309 are configured to receive performance data from the distributed systems 307, and provide real-time performance data to the autonomous index orchestrator 305. The autonomous index orchestrator 305 utilizes the real-time performance data, as well as the predicted index size and index creation information from the resource-aware indexer 303, to predict resource availability in the distributed systems 307, and to control index creation in the distributed systems 307 (e.g., to start, pause and resume index creation operations in the distributed systems 307). The autonomous index orchestrator 305 is further configured to provide reporting and monitoring functionality, as the autonomous index lifecycle management framework 301 may generate reports 311 based on the success or failure of index creation and optimization efforts. This data provides valuable insights for further refinement and optimization.

The autonomous index lifecycle management framework 301 provides various technical advantages, including: enhanced performance through optimizing query performance and reducing response times; reduced operational costs through eliminating manual tasks, saving time and resources; improved data accessibility though ensuring efficient data retrieval and sharing; enhanced data exchange efficiency through facilitating seamless data integration and collaboration; and scalability through handling large-scale distributed systems and dynamic data workloads. The autonomous index lifecycle management framework 301 further benefits various applications, including: data exchanges through optimizing data discovery, distribution and sharing; data brokers through improving data mediation and integration efficiency; geographically-distributed datasets through managing indexes across geographically dispersed systems; and machine learning through supporting data-intensive applications and evolving data models. The autonomous index lifecycle management framework 301 provides significant advancements in index management for the distributed systems 307. Through autonomous index management and optimization of resource allocation, the autonomous index lifecycle management framework 301 empowers organizations to improve data exchange efficiency, reduce costs and enhance data accessibility.

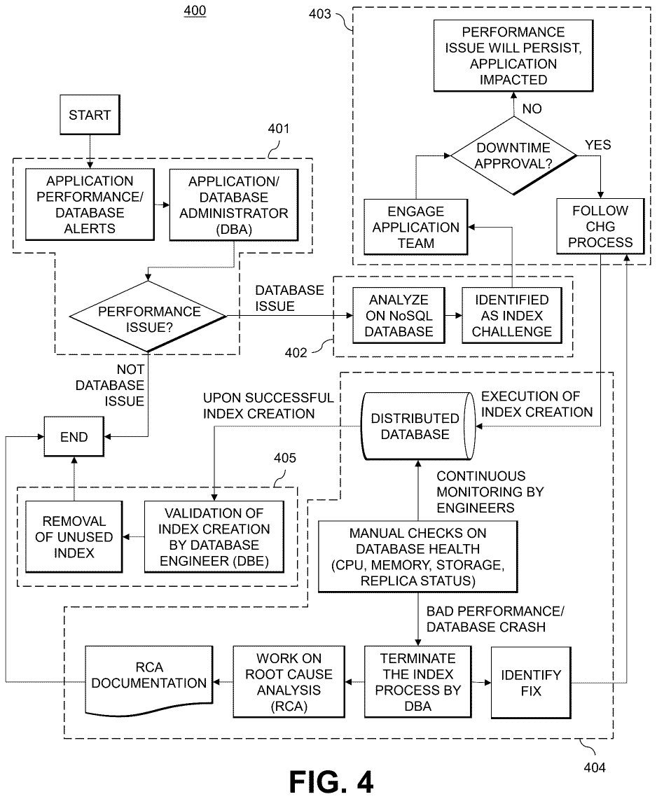

Managing indexes in distributed systems is a complex task, due to heterogeneous indexing strategies, inconsistent schemas, and the need for real-time updates. Optimizing indexes for diverse query patterns, ensuring data quality, and addressing security and privacy concerns are critical. Balancing index creation and maintenance costs with query performance benefits is essential for efficient data exchange. FIG. 4 shows a process flow 400 for index management in a distributed data system, illustrating technical challenges at various stages 401, 402, 403, 404 and 405.

Stage 401: At the start, application performance and/or database alerts are generated, which are manually addressed by application or database administrators (DBAs). If there is a performance issue, a manual determination is made as to whether the performance issue is a database issue or not. In distributed systems, such as data exchanges, data broker environments and geographically distributed datasets, manual index management for dynamically generated queries can be inefficient and error prone. This approach often suffers from various limitations, including that such approaches are time-consuming, error-prone and unscalable for frequent changes. Manually analyzing resource needs, assessing query impact, and managing indexes is a laborious process that can slow down development cycles and operations. Human errors in resource allocation, query impact assessment or configuration can lead to poor query performance (e.g., resulting in slow queries and sluggish applications) and data loss, especially in large-scale distributed systems. Dynamic data models and evolving query patterns in distributed environments make manual maintenance challenging. Keeping up with these changes and maintaining optimal index performance can hinder agility.

Stage 402: If the performance issue is determined to be a database issue, the issue is analyzed on a NoSQL database and may be identified as an index challenge or issue. This manual index analysis presents a bottleneck in distributed data environments. Optimizing query performance in distributed systems, such as data exchanges, data broker environments and geographically-distributed datasets, relies heavily on well-designed indexes. However, critical challenges lie in efficiently analyzing two crucial aspects of index creation-inaccurate resource estimation and query impact. Manually assessing memory, CPU and storage requirements for indexes can lead to resource bottlenecks due to underestimation, wasted resources due to overestimation, and inefficient distributed systems operation due to inaccurate allocation. Evaluating how an index will affect the performance of specific queries in distributed systems is time-consuming and prone to errors. Inaccurate assessment can result in: poor index design, leading to suboptimal query performance; wasted development time on inefficient indexes; and suboptimal query performance due to misaligned indexes.

Stage 403: Once a performance issue is identified as an index challenge or issue, an application team discussion may be initiated to engage the relevant application team, and a determination is made as to whether downtime is approved to address the issue. If the downtime is not approved, then the performance issue will persist and the application will be impacted (e.g., until disruptive downtime is approved or off-hours deployment may be performed). If the downtime is approved, then the change (CHG) process is followed. This illustrates the downtime dilemma of index creation in distributed systems. Creating indexes in distributed systems, especially large-scale environments, can often lead to disruptive downtime. This is due to the resource-intensive nature of index creation and the potential for conflicts with other database operations. Index creation can require taking entire databases offline, impacting application availability and user experience (e.g., leading to disruptive downtime). To avoid disruptions, administrators may resort to creating indexes during non-peak hours (e.g., off-hours deployments), limiting operational flexibility. These limitations present several challenges, including: reduced application availability, as downtime can negatively impact user experience and potentially lead to financial loss; limited operational flexibility, as relying on off-hours deployments restricts scheduling and can increase complexity; and increased operational costs, as additional resources and planning may be necessary to accommodate downtime and off-hours work.

Stage 404: The CHG process includes execution of index creation in a distributed database, with continuous monitoring by engineers. This includes manual checks on database server health (e.g., CPU, memory, storage and replica status). If there is poor performance or a database crash, a DBA will terminate the index creation process. Root Cause Analysis (RCA) may be performed, which leads to creation of RCA documentation. If a fix is identified, this is implemented and the index creation may be re-executed following implementation of the fix. Creating indexes in large distributed systems can overload and crash databases, requiring manual monitoring to prevent downtime. In distributed systems, such as data exchanges, data broker environments and geographically-distributed datasets, creating indexes in large-scale distributed system can be time-consuming and resource intensive. This inefficiency can lead to several challenges, including; downtime threats, as prolonged index creation can strain system resources, increasing the risk of overload and crashes, resulting in application downtime and potential revenue loss; increased operational overhead, as DBAs must manually monitor index creation to mitigate downtime risks, adding to their workload and diverting attention from other critical tasks; operational inefficiency, as slow index creation disrupts ongoing operations, hindering overall productivity; and potential data loss, as in worst-case scenarios, data loss during index creation can lead to data loss or corruption.

Stage 405: Upon successful index creation, the created index is validated manually by a database engineer (DBE), potentially followed by removal of one or more unused indexes. This leads to inefficiencies related to manual index validation and rollback in distributed systems. In distributed data environments, validating and rolling back indexes can be time-consuming and resource intensive. This is particularly true for large-scale systems and complex data exchanges. Evaluating the effectiveness of indexes requires careful analysis of query performance, which can be resource intensive and leads to time-consuming validation processing. Further, identifying, backing up and removing unused indexes can consume significant resources, especially in distributed environments.

Conventional distributed systems suffer from critical inefficiencies related to manual index management, especially in environments with dynamic data models and query patterns. The technical solutions described herein provide an Autonomous Index Lifecycle Management System (AILMS), also referred to as an autonomous index lifecycle management framework, which provides functionality for complete control of the entire index lifecycle, from identifying truly necessary indexes to ongoing maintenance.

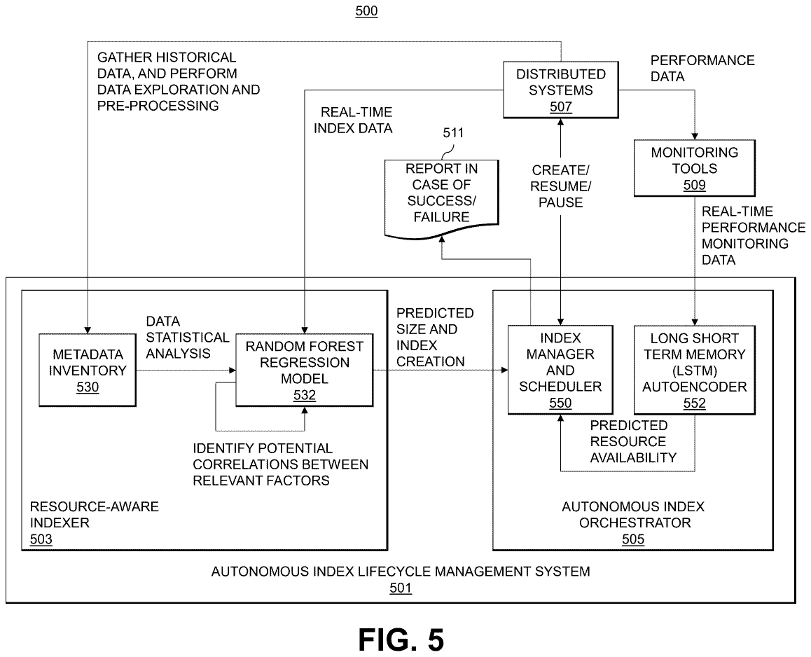

FIG. 5 shows a system 500 implementing AILMS 501, which comprises a resource-aware indexer 503 and an autonomous index orchestrator 505. The system 500 also includes one or more distributed systems 507 and one or more monitoring tools 509. The resource-aware indexer 503 includes a metadata inventory 530, which gathers historical data from the distributed systems 507 and performs data exploration and pre-processing. The resource-aware indexer 503 also includes random forest regression model 532, which obtains real-time index data from the distributed systems, along with data statistical analysis from the metadata inventory 530, and uses such data to identify potential correlations between relevant factors. The autonomous index orchestrator 505 includes an index manager and scheduler 550 and an LSTM Autoencoder 552. The index manager and scheduler 550 is configured to manage the entire index lifecycle using the LSTM Autoencoder 552 for decision-making and continuous improvement. The monitoring tools 509 obtain performance data from the distributed systems 507, and provide real-time performance monitoring data to the LSTM Autoencoder 552. The LSTM Autoencoder 552 uses such information to provide predicted resource availability to the index manager and scheduler 550. The index manager and scheduler 550 also receives, from the random forest regression model 532, index creation tasks and the predicted size (e.g., in gigabytes (GB)) of indexes to be created. The index manager and scheduler 550 utilizes such information to start, pause and resume index creation in the distributed systems 507. The index manager and scheduler 550 may also be configured to generate reports 511 indicating success/failure of index creation tasks.

The metadata inventory 530 uses various data sources in the distributed systems 507 to gather the historical data and perform data exploration and pre-processing. The historical data may be related to distributed system operations and performance metrics, which is preprocessed to prepare it for further analysis. The monitoring tools 509 are configured to monitor the distributed systems 507 in real-time, gathering data on factors such as CPU usage, memory usage, IO activity, etc. The resource-aware indexer 503 and the autonomous index orchestrator 505 in the AIMLS 501 work together to analyze the gathered data and make decisions about index creation. The resource-aware indexer 503 is configured to assess the need for new indexes, based on factors like data access patterns, resource availability, etc. The random forest regression model 532 is configured, based on data statistical analysis provided by the metadata inventory 530, to identify potential correlations between relevant factors that could influence indexing decisions. The metadata inventory 530 is configured to provide a repository that stores information about existing indexes in the distributed systems 507, including the data they pertain to and their usage patterns.

The autonomous index orchestrator 505 is configured to orchestrate the overall indexing process in the distributed systems 507. The resource-aware indexer 503 is configured to utilize the metadata inventory 530 to predict the size of an index that is to be created based on the data being considered for indexing. This prediction may be based on historical data, statistical models, combinations thereof, etc. The index manager and scheduler 550 of the autonomous index orchestrator 505 is configured to handle the creation and removal of indexes based on the decisions made by the AILMS 501. The index manager and scheduler 550 is also configured to track the success or failure of index creation operations.

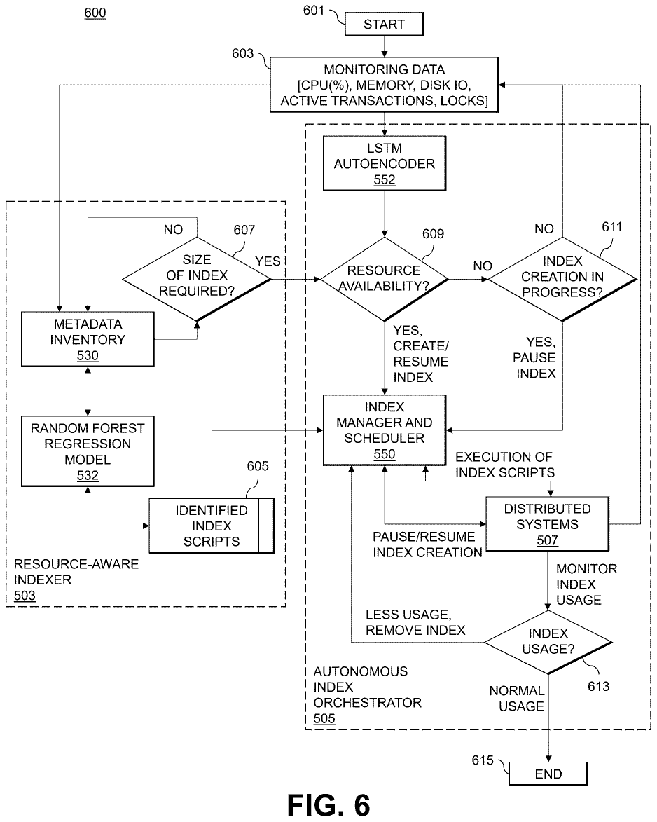

FIG. 6 shows a process flow 600 for autonomous index lifecycle management which may be performed utilizing the AILMS 501. The process flow 600 begins in block 601, and monitoring data (e.g., CPU usage, memory usage, disk IO, active transactions, locks, etc.) is collected from distributed systems 507 in block 603. The monitoring data is fed into the resource-aware indexer 503 for further processing. The resource-aware indexer 503 will check the metadata inventory 530, which contains information about existing indexes and the data they pertain to. The resource-aware indexer 503 then determines if creating an index is necessary, based on factors like the data and resource availability. The resource-aware indexer 503 uses the random forest regression model 532 to predict the size of the index that would be created based on the data being considered for indexing, and generates identified index scripts in block 605. The identified index scripts are pre-defined scripts for creating specific indexes, which may be used to trigger the index creation process. The identified index scripts are provided to the index manager and scheduler 550 of the autonomous index orchestrator 505. In block 607, a determination is made as to whether the size of the index required is known. If the result of the block 607 determination is no, the metadata inventory 530 is used to determine this size. If the result of the block 607 determination is yes, the process flow proceeds to block 609.

In block 609, resource availability is evaluated. The autonomous index orchestrator 505 uses the LSTM Autoencoder 552 (which is a type of neural network used for dimensionality reduction and anomaly detection) to compress the monitoring data collected in block 603 and identify any unusual patterns that could indicate potential performance issues. Such information is fed into the resource availability evaluation in block 609, along with the size of the index that is required. In block 609, resource availability is evaluated to check if sufficient resources are available to create the index, and whether the distributed systems 507 are currently available for creating the index. Index creation may involve creating or resuming an index, indicating that the system can either create a new index from scratch or resume a paused indexing process. If the result of the block 609 evaluation is yes, then the index manager and scheduler 550 is used to create or resume index creation on the distributed systems 507. To do so, the index manager and scheduler 550 may utilize one of the identified index scripts from block 605. If the result of the block 609 evaluation is no (e.g., resources are unavailable or the distributed systems 507 are not available), the process flow proceeds to block 611 where a determination is made as to whether index creation is currently in progress. If the result of the block 611 determination is no, the process flow 600 loops back to block 603. If the result of the block 611 determination is yes, then the index manager and scheduler 550 is used to pause the index creation on the distributed systems 507.

Following index creation, the process flow 600 includes a feedback loop where index usage in the distributed systems 507 is monitored (e.g., to determine how often a created index is being used for queries). In block 613, a determination is made as to whether the index usage is normal or less than normal. If the result of the block 613 determination indicates that the index usage is normal (e.g., within normal limits as defined by one or more thresholds), the process flow 600 ends in block 615. It should be noted, however, that the index usage may be continuously monitored, as index usage may initially be normal and later become abnormal (e.g., “less” than normal usage). If the result of the block 613 determination indicates that the index usage is less than normal (e.g., less than normal limits as defined by one or more thresholds), this indicates that the created index is not being used frequently and the index manager and scheduler 550 may decide to remove the created index to free up storage space and other resources.

The process flow 600 depicts how the AILMS 501 can autonomously manage the lifecycle of indexes in the distributed systems 507. The AILMS 501 considers or takes into account various factors, including resource availability, predicted index size, and actual usage to optimize index creation and improve storage efficiency. The AILMS 501 can provide various technical advantages, including improved query performance by creating appropriate indexes, reduced storage overhead by removing unnecessary indexes, and simplified data management through autonomous index lifecycle management.

Distributed data systems offer agility and scalability, but efficient index management in distributed data systems presents technical challenges. The AILMS 501, using the resource-aware indexer 503, is able to overcome or mitigate at least some of such technical challenges by intelligently predicting resource requirements for index creation. In the description below, the index creation resource requirement predictions are described with respect to a NoSQL database (e.g., MongoDB), though it should be appreciated that index creation resource requirement predictions can also be made and implemented for other types of databases and data storage systems. In some embodiments, the resource-aware indexer 503 is configured to collect resource-consuming queries and recommended indexes for all NoSQL systems which are configured and enabled for resource-aware indexing features and functionality. This includes tables, index metadata and queries. The resource-aware indexer 503 is configured to utilize the random forest regression model 532 to predict the resource requirements for index creation, where such predictions may be based on data such as; index statistics and metadata inventory 530 collection; index data load and preprocessing; random forest regression model training; and prediction of index size.

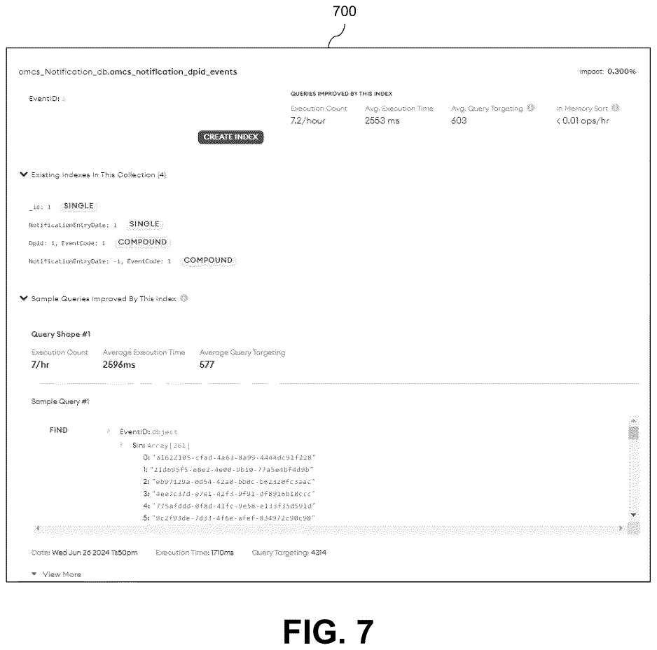

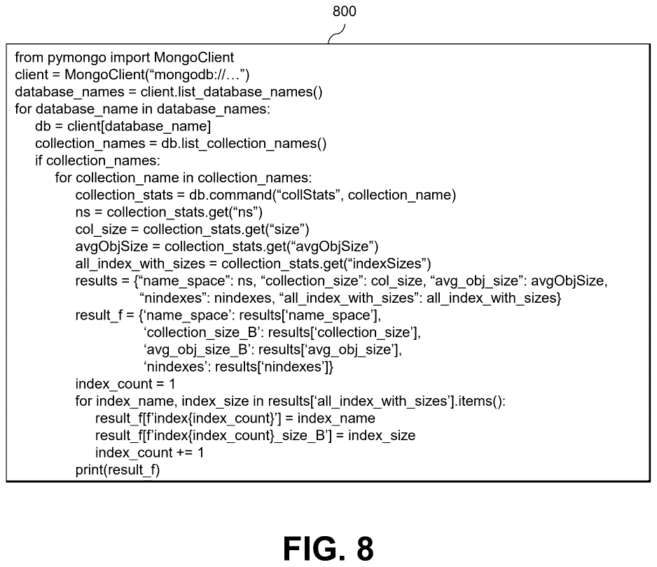

Index statistics and the metadata inventory 530 collection will now be described. Once an environment (e.g., one or more servers of distributed system 507) is enabled for resource-aware indexing, inventory jobs will be scheduled to gather the required data for predicting the index size. In some embodiments, the following data is collected and utilized for prediction: collection information, including database name, collection name, collection size (e.g., total data volume), and average object size (e.g., average document size); field details for a recommended index, including field name and field type (e.g., data type of the field); existing indexes, including the presence of existing indexes (e.g., yes/no), indexed fields (e.g., a list of fields included in the existing indexes), index type (e.g., hash, unique, time series), index size (e.g., physical storage space occupied by the existing indexes); and index statistics, including index recommendations on queries having a high run time and/or which consume more resources with a higher impact and potential performance improvement. FIG. 7 shows an example of index statistics 700 including details of indexes recommended for a sample query in a particular collection, along with the execution count for queries and the improvement for the query execution. This data will be used as an input for selecting indexes with the highest or higher impact which are fed into the resource-aware indexer 503 for further analysis and possible index creation. FIG. 8 shows pseudocode 800 for collecting metadata from a MongoDB collection along with other index details.

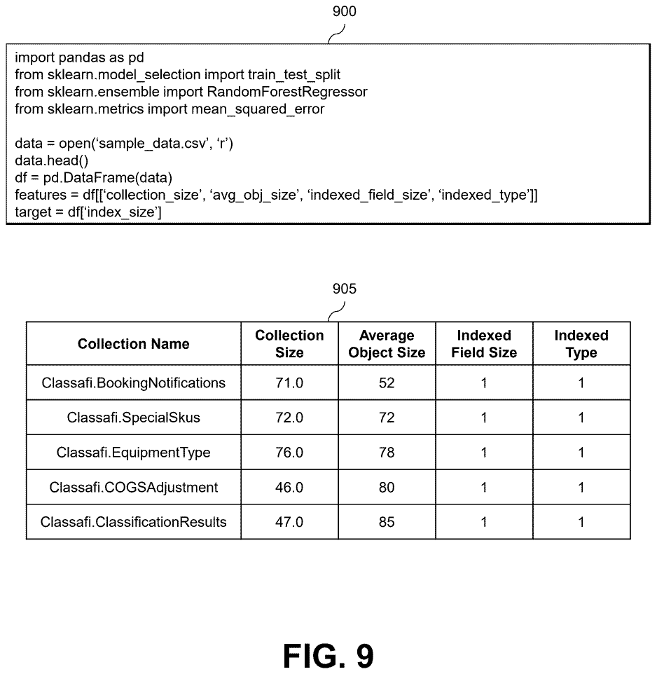

Index data load and pre-processing will now be described. Index and collection data is loaded into a centralized repository, and the data is pre-processed to provide as input to the random forest regression model 532. Linear regression models can be used to predict the index size, but with complex relationships Random Forest regression is better suited for complex data sets and relationships without explicit assumptions. Sample data is taken in a comma-separated value (CSV) format and loaded into a pandas data frame, along with required input and output parameters which are defined to train the random forest regression model 532. FIG. 9 shows pseudocode 900 for performing the index data load, along with a table 905 of the index data.

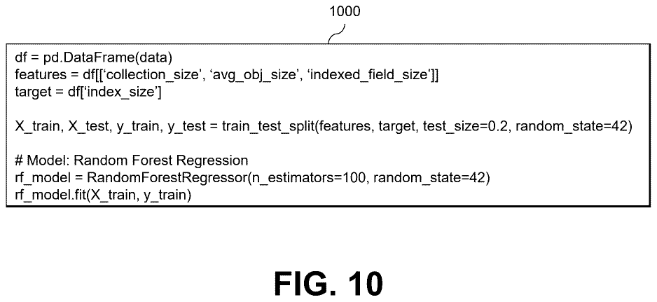

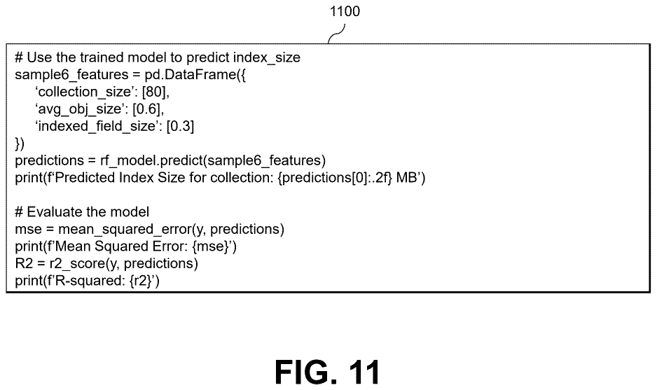

Training of the random forest regression model 532 will now be described. The collection size, the average object size and the index field size for a particular index are used as inputs for predicting the index size. Pre-processed data in these fields are used to train the random forest regression model 532 with random state and estimators. FIG. 10 shows pseudocode 1000 for training of the random forest regression model 532. An example of index size prediction will now be described. Sample values for index fields are passed to the trained model. FIG. 11 shows pseudocode 1100 for inputting the sample values, which returns the predicted value of the index size (e.g., in this example, “Predicted Index Size for collection: 3.76 MB”). The pseudocode 1100 further evaluates the trained model using mean squared error (MSE) and r-squared (R2) methods (e.g., with the results in this example being “Mean-Squared Error: 0.19656” and “R-squared; 0.8718309859154929”). The predicted index size (e.g., memory requirements) is used as an input to the autonomous index orchestrator 505 for creating the index in a database (e.g., of distributed systems 507), and for validation of the index usage in the database after index creation.

The autonomous index orchestrator 505 is configured for automating processes to intelligently maintain and manage the lifecycle of indexes, including index creation processes. The autonomous index orchestrator 505 takes index size requirements and database performance metrics as inputs to determine the workload of a database server (e.g., of distributed systems 507) using LSTM Autoencoder 552, and manages the index creation utilizing the index manager and scheduler 550. The index manager and scheduler 550 will start index creation when the database has available resources (e.g., which may correspond to the database running under a normal workload), and continuously monitors the load during the index creation process. In case the workload of the database increases beyond some designated thresholds (e.g., characterizing the normal workload), the index manager and scheduler 550 will pause the index creation. The index creation is later resumed when the index manager and scheduler 550 determines that the database has available resources (e.g., that the database has returned to its normal workload). After index creation is completed, the index manager and scheduler 550 will validate the index usage from database performance metrics and determine whether to keep or drop the index. The autonomous index orchestrator 505 utilizes various components and information to manage the lifecycle of index creation in the distributed systems 507, including: the predicted index size and index statement from the resource-aware indexer 503; database performance metrics from monitoring tools 509; LSTM Autoencoder 552 for load factor prediction; and the index manager and scheduler 550 for starting, pausing and resuming index creation processes, as well as determining whether to retain or drop indexes created in the distributed systems 507.

The resource-aware indexer 503 will gather required index statistics and metadata information related to indexing, and predict the size of an index to be created utilizing the random forest regression model 532. Indexes with higher performance impact will be chosen for creation, and their predicted size will be passed as input to the autonomous index orchestrator 505 which manages index creation based on the monitored workload of the distributed systems 507.

The workload of the distributed systems 507 may be monitored utilizing real-time performance data that is obtained from the monitoring tools 509. Database performance metrics, such as CPU, memory, disk IO, active transactions and database locks over a designated period of time are used as input to determine the workload of the database system. This data may be continuously fetched from the monitoring tools 509, which are configured to collect performance data from the distributed systems 507. Such data will be pre-processed and fed as input to an analytical model (e.g., the LSTM Autoencoder 552), which is trained with historical data and validated with live data to predict a load factor threshold for the distributed systems 507.

The autonomous index orchestrator 505 uses the LSTM Autoencoder 552 for load factor predictions. In some embodiments, LSTM is selected as the machine learning model type to use for predicting the load factor threshold. LSTM is a type of artificial recurrent neural network (RNN). LSTM is based on the basic structure of RNNs, which are designed to handle sequential data, where the output from the previous step is fed as input to the current step. LSTM is an improved version of a basic RNN which has three different “memory” gates: a forget gate, an input gate and an output gate. The forget gate controls what information in the cell state to forget, given the latest information that entered from the input gate. Here, the performance data is time series data and LSTM is a good fit for it. Since the goal is not only forecasting a single metric, but to find a global anomaly in all metrics combined (e.g., CPU, memory, disk IO, active transactions, locks, etc.), the LSTM alone cannot provide the global perspective that is needed. Thus, an autoencoder is added. The LSTM Autoencoder 552 is an implementation of an autoencoder for sequential data using an Encoder-Decoder LSTM architecture. The LSTM Autoencoder 552 advantageously has the benefits of both LSTM and autoencoder models, The LSTM Autoencoder 552 will determine the load factor threshold based on the database performance metrics, and the same will be used to start, pause and resume index creation processes.

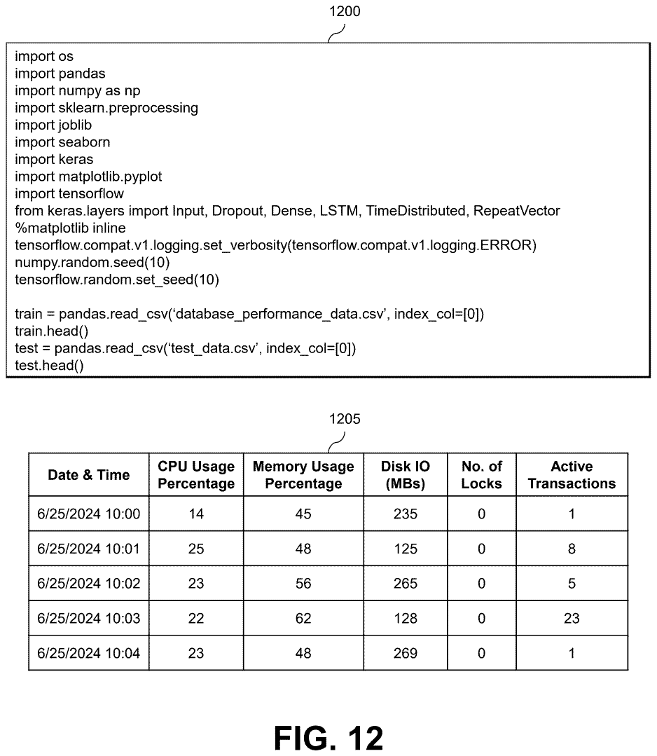

Data loading and pre-processing for the LSTM Autoencoder 552 will now be described. In this example, the “database_performance_data.csv” file is the subset of database performance data under normal operating conditions, and the “test_data.csv” is the subset of database metrics which contains normal data as well as transactions with high load. Data in the “database_performance_data.csv” file is used to train the LSTM model, and the “test_data.csv” file is used to validate the trained LSTM model. FIG. 12 shows pseudocode 1200 for initializing the machine learning (ML) libraries and passing the transaction details as input for training and validation of the LSTM data model, as well as a table 1205 showing a distribution of database metrics in the idle state.

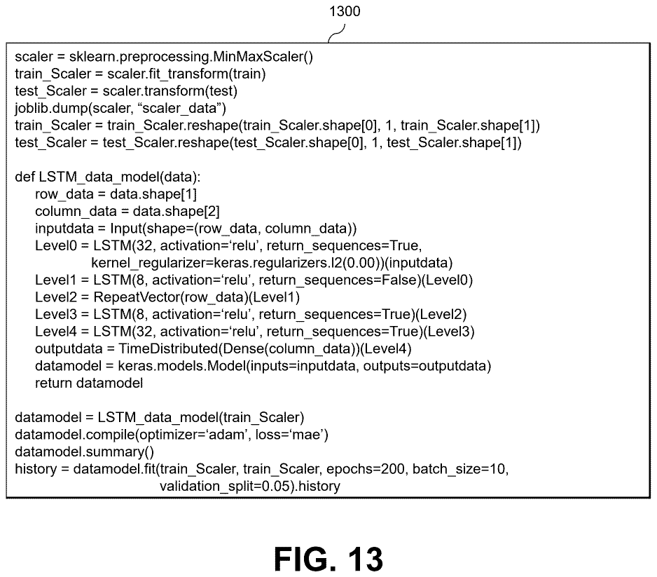

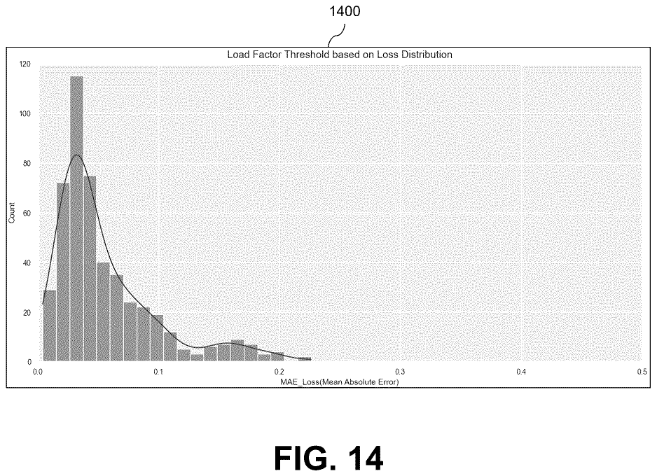

The LSTM Autoencoder 552 has multiple layers of neural networks, in which the first few of them will take the input, create the compressed representation of data, encode the compressed representation, and use a repeat vector layer to distribute the compressed data across time steps of a decoder. In some embodiments, the model uses Adam as a neural network optimizer for the compilation. Normal database performance metrics are contained in the “database_performance_data.csv” file used for training the model. FIG. 13 shows pseudocode 1300 for creating and training the model for the LSTM Autoencoder 552. MAE is used for calculating loss in the training dataset by the LSTM Autoencoder 552. FIG. 14 shows a plot 1400 of the distribution of the calculated loss in the training dataset. Based on the distribution, a suitable threshold can be determined for detecting the load on a database server.

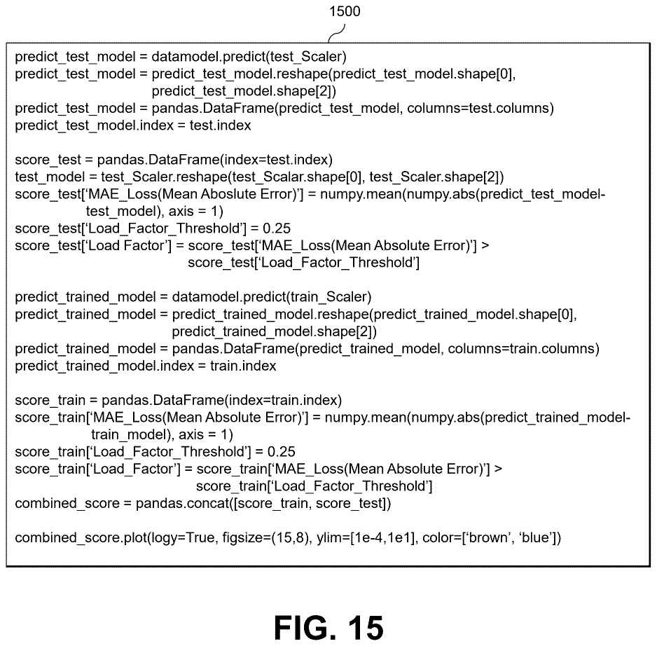

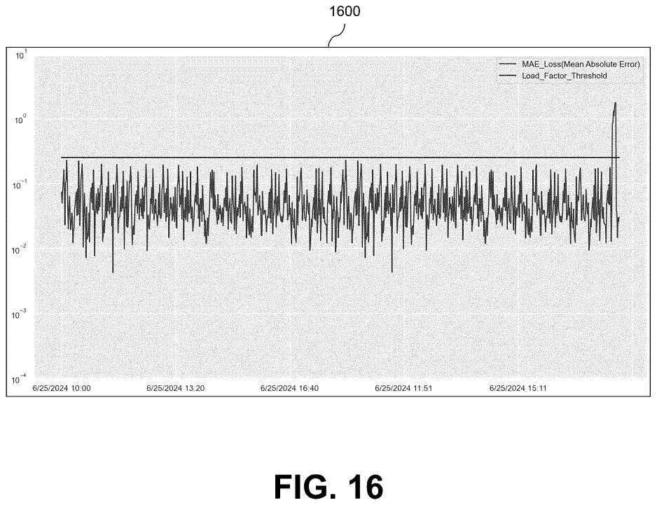

The load factor may be determined based on the distribution of MAE loss. In the example shown in the plot 1400, the threshold for the load factor can be set as 0.25. This will make sure that the threshold set is above existing values of the normal dataset, so index creation can be paused above the load factor threshold value to prevent potentially negative impacts on the database. FIG. 15 shows pseudocode 1500 for testing the LSTM Autoencoder 552 by passing the database metrics above the load factor threshold in the “test_data.csv” file as input. This test data file has the transactions for which the MAE exceeds the load factor threshold value of 0.25, thus representing the database operating over its normal load. FIG. 16 shows a plot 1600 of the MAE and load factor threshold, illustrating validation of the load factor threshold.

In the AILMS 501, the index manager and scheduler 550 provides index management and index creation scheduling functionality. The index manager and scheduler 550 may include an index scheduler implemented as an application-based scheduler host in a VM or cloud computing environment which handles the process for index creation in one or more databases of the distributed systems 507. The index scheduler will receive index statements, server resources and workload predictions from the LSTM Autoencoder 552, and the size of the index required from the resource-aware indexer 503 as inputs, and controls the index creation process on the one or more databases of the distributed systems 507 based on the current workload and available database server resources. Whenever there is sufficient resources available for index creation, the index manager and scheduler 550 will trigger the index creation script and receive continuous updates on the server workload from the LSTM Autoencoder 552. If there is an increase in workload higher than the load factor threshold, the index manager and scheduler 550 will pause the index creation process, and later will resume the index creation process when the workload is back to normal below the load factor threshold. After completion of the index creation process, the index manager and scheduler 550 will review the database performance monitoring data to check the index usage for queries, and may drop the index if it is unused or underutilized according to some designated threshold. The index manager and scheduler 550 handles the creation, monitoring, and removal of indexes based on usage data and predefined schedules. The index manager and scheduler 550 initiates the process by triggering indexing tasks, and potentially optimizing scheduling based on system conditions. The management and scheduling functionality of the index manager and scheduler 550 work together to ensure that indexes are created and maintained effectively for optimal performance.

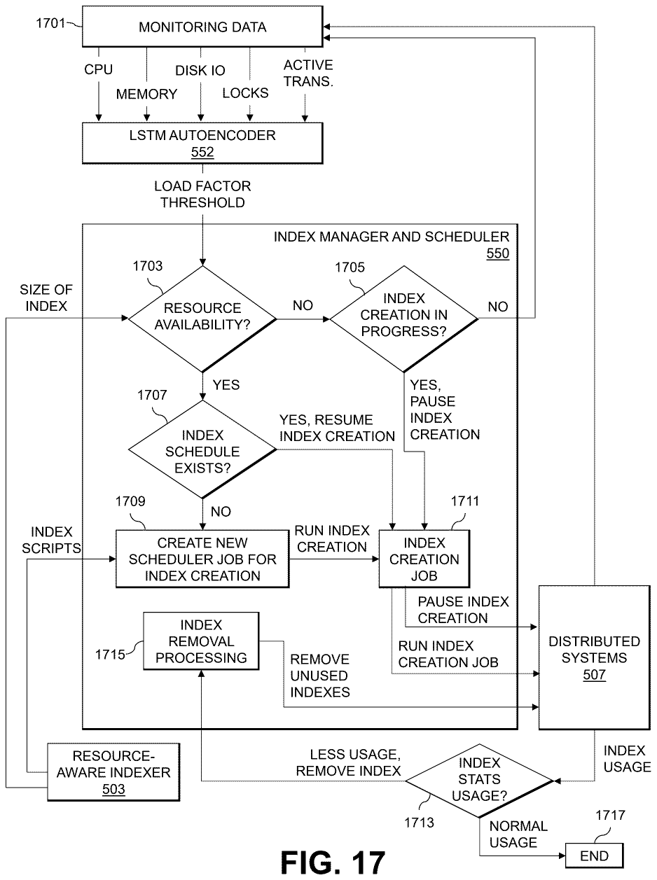

FIG. 17 shows a process flow 1700 for index management and scheduling as part of autonomous index lifecycle management which may be performed utilizing the AILMS 501. The process flow 1700 begins in block 1701, where monitoring data (e.g., CPU, memory, disk IO, locks, active transactions) is obtained from distributed systems 507 and provided to the LSTM Autoencoder 552. The LSTM Autoencoder 552 uses the monitoring data to determine a load factor threshold, which is provided to the index manager and scheduler 550, In block 1703, a determination is made as to whether there are sufficient available resources, based on the size of an index to be created (received as input from resource-aware indexer 503) and the load factor threshold. If the result of the block 1703 determination is no, the process flow 1700 proceeds to block 1705, where a determination is made as to whether index creation is already in progress. If the result of the block 1705 determination is no, the process flow 1700 returns to block 1701. If the result of the block 1705 determination is yes, an index creation job 1711 is instructed to pause index creation. If the result of the block 1703 determination is yes, the process flow 1700 proceeds to block 1707.

In block 1707, a determination is made as to whether an index schedule exists for the index to be created. If the result of the block 1707 determination is yes, then the index creation job 1711 is instructed to resume index creation. If the result of the block 1707 determination is no, the process flow 1700 proceeds to block 1709 where a new scheduler job is created for index creation. Block 1709 may utilize one or more index scripts obtained from the resource-aware indexer 503. Once created, an instruction to run index creation is provided to the index creation job 1711. The index creation job 1711 is configured to run and pause the index creation job on the distributed systems 507, as instructed by blocks 1705, 1707 and 1709. Once the index creation job is finished, usage of the created index in the distributed systems 507 is monitored. In block 1713, index usage statistics are evaluated to determine whether index usage is normal or less than normal, where “normal” usage may be determined according to one or more designated thresholds. If the result of the block 1713 determination is that the index usage is less or below normal, the process flow 1700 proceeds to index removal processing in block 1715. The index removal processing in block 1715 is configured to instruct the distributed systems to remove unused or underutilized indexes. If the result of the block 1713 determination is that the index usage is normal, the process flow 1700 ends in block 1717.

Before an index is created in the distributed systems 507, the resource-aware indexer 503 is configured to analyze the complex data sets and nonlinear multiple relationships to determine the size of the index in relation to the resources requirements (e.g., utilizing random forest regression model 532). The autonomous index orchestrator 505 uses the LSTM Autoencoder 552 as a prediction model to determine a load factor threshold, and uses the index manager and scheduler 550 to intelligently orchestrate the index lifecycle, including creation, validation and monitoring based on performance parameters of the distributed systems 507.

There are multiple scenarios in real-time environments where index creation on distributed systems (e.g., a large, distributed NoSQL database system) takes a long time to complete, and may end up crashing database services or servers of the distributed systems. Manual index creation of an index with a data size of more than 1 terabyte (TB), for example, is a time-consuming process with continuous monitoring of the server resources and potentially execution during off hours to avoid impacting application workloads. In a conventional approach, a real-time distributed system in production (e.g., a MongoDB database system) may crash during index creation due to various issues, such as memory issues. Usage of the resource-aware indexer 503, however, would predict the resource requirements for such index creation before it begins, and the autonomous index orchestrator 505 would intelligently start, pause and resume index creation when detecting increase in resource usage and application workload during the index creation in order to avoid such crashes.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for orchestration of index creation in distributed systems will now be described in greater detail with reference to FIGS. 18 and 19. Although described in the context of system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that may be utilized to implement at least a portion of the information processing system 100 in FIG. 1. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 1800 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 may comprise respective VMs, respective sets of one or more containers, or respective sets of one or more containers running in VMs.

In some implementations of the FIG. 18 embodiment, the VMs/container sets 1802 comprise respective VMs implemented using virtualization infrastructure 1804 that comprises at least one hypervisor. A hypervisor platform may be used to implement a hypervisor within the virtualization infrastructure 1804, where the hypervisor platform has an associated virtual infrastructure management system. The underlying physical machines may comprise one or more distributed processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of system 100 and includes a plurality of processing devices, denoted 1902-1, 1902-2, 1902-3, . . . 1902-K, which communicate with one another over a network 1904.

The network 1904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1902-1 in the processing platform 1900 comprises a processor 1910 coupled to a memory 1912.

The processor 1910 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1912 may comprise random access memory (RAM), read-only memory (ROM), flash memory or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for orchestration of index creation in distributed systems as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. An apparatus comprising:
at least one processing device comprising a processor coupled to a memory;
the at least one processing device being configured:
to monitor one or more distributed systems to determine (i) index data associated with usage of one or more indexes in the one or more distributed systems and (ii) performance data associated with the one or more distributed systems;
to determine, utilizing a first machine learning model that takes as input at least a portion of a first data structure characterizing the index data associated with the usage of the one or more indexes in the one or more distributed systems, at least one additional index to be created in the one or more distributed systems and a predicted size of the at least one additional index;
to determine, utilizing a second machine learning model that takes as input at least a portion of a second data structure characterizing the performance data associated with the one or more distributed systems, a load factor threshold for the one or more distributed systems;
to predict resource requirements associated with creation of the at least one additional index in the one or more distributed systems based at least in part on the predicted size of the at least one additional index;
to control creation of the at least one additional index in the one or more distributed systems based at least in part on (i) the predicted resource requirements associated with the creation of the at least one additional index in the one or more distributed systems and (ii) determining whether a current workload of the one or more distributed systems exceeds the determined load factor threshold for the one or more distributed systems; and
responsive to determining that the creation of the at least one additional index in the one or more distributed systems is completed, to monitor usage of the created at least one additional index in the one or more distributed systems and to determine whether to retain the created at least one additional index in the one or more distributed systems based at least in part on the monitored usage of the created at least one additional index.

2. The apparatus of claim 1 wherein the one or more distributed systems comprise a distributed database system.

3. The apparatus of claim 1 wherein the one or more distributed systems comprise one or more geographically-dispersed datasets including at least a first portion of data in a first geographic location and a second portion of data in a second geographic location.

4. The apparatus of claim 1 wherein the one or more distributed systems comprise an information technology infrastructure implementing data sharing across a plurality of information technology assets.

5. The apparatus of claim 1 wherein the first machine learning model comprises a random forest regression model.

6. The apparatus of claim 1 wherein the index data associated with the usage of the one or more indexes in the one or more distributed systems comprises information characterizing: one or more existing indexes utilized in the one or more distributed systems; query patterns for queries in the one or more distributed systems; and usage of the one or more existing indexes by the queries in the one or more distributed systems.

7. (canceled)

8. (canceled)

9. The apparatus of claim 1 wherein the at least one processing device is further configured, responsive to determining that the creation of the at least one additional index in the one or more distributed systems is completed, to validate the created at least one additional index based at least in part on comparing a size of the created at least one additional index to the predicted size of the at least one additional index.

10. The apparatus of claim 1 wherein determining the at least one additional index to be created in the one or more distributed systems further comprises generating an index creation script for initiating creation of the at least one additional index in the one or more distributed systems, and wherein controlling the creation of the at least one additional index in the one or more distributed systems comprises initiating an index creation job in the one or more distributed systems utilizing the generated index creation script.

11. The apparatus of claim 1 wherein the second machine learning model comprises a Long Short Term Memory (LSTM) Autoencoder.

12. The apparatus of claim 1 wherein determining the load factor threshold for the one or more distributed systems comprises:
utilizing the second machine learning model to determine a loss distribution for a portion of the performance data associated with the one or more distributed systems characterizing normal operation of the one or more distributed systems; and
selecting the load factor threshold based at least in part on the determined loss distribution for the portion of the monitored performance data associated with the one or more distributed systems characterizing the normal operation of the one or more distributed systems.

13. The apparatus of claim 1 wherein controlling the creation of the at least one additional index in the one or more distributed systems comprises:
initiating, responsive to detecting that the one or more distributed systems have sufficient available resources according to the determined load factor threshold, an index creation job in the one or more distributed systems to create the at least one additional index;
pausing the index creation job responsive to detecting that the index creation job is currently running and that the one or more distributed systems do not have sufficient available resources according to the determined load factor threshold; and
resuming the index creation job responsive to detecting that the index creation job is paused and the one or more distributed systems have sufficient available resources according to the determined load factor threshold.

14. (canceled)

15. A computer program product comprising a non-transitory processor-readable storage medium having stored therein program code of one or more software programs, wherein the program code when executed by at least one processing device causes the at least one processing device:
to monitor one or more distributed systems to determine (i) index data associated with usage of one or more indexes in the one or more distributed systems and (ii) performance data associated with the one or more distributed systems;
to determine, utilizing a first machine learning model that takes as input at least a portion of a first data structure characterizing the index data associated with the usage of the one or more indexes in the one or more distributed systems, at least one additional index to be created in the one or more distributed systems and a predicted size of the at least one additional index;
to determine, utilizing a second machine learning model that takes as input at least a portion of a second data structure characterizing the performance data associated with the one or more distributed systems, a load factor threshold for the one or more distributed systems;
to predict resource requirements associated with creation of the at least one additional index in the one or more distributed systems based at least in part on the predicted size of the at least one additional index;
to control creation of the at least one additional index in the one or more distributed systems based at least in part on (i) the predicted resource requirements associated with the creation of the at least one additional index in the one or more distributed systems and (ii) determining whether a current workload of the one or more distributed systems exceeds the determined load factor threshold for the one or more distributed systems; and
responsive to determining that the creation of the at least one additional index in the one or more distributed systems is completed, to monitor usage of the created at least one additional index in the one or more distributed systems and to determine whether to retain the created at least one additional index in the one or more distributed systems based at least in part on the monitored usage of the created at least one additional index.

16. The computer program product of claim 15 wherein controlling the creation of the at least one additional index in the one or more distributed systems comprises:
initiating, responsive to detecting that the one or more distributed systems have sufficient available resources according to the determined load factor threshold, an index creation job in the one or more distributed systems to create the at least one additional index;
pausing the index creation job responsive to detecting that the index creation job is currently running and that the one or more distributed systems do not have sufficient available resources according to the determined load factor threshold; and
resuming the index creation job responsive to detecting that the index creation job is paused and the one or more distributed systems have sufficient available resources according to the determined load factor threshold.

17. (canceled)

18. A method comprising:
monitoring one or more distributed systems to determine (i) index data associated with usage of one or more indexes in the one or more distributed systems and (ii) performance data associated with the one or more distributed systems;
determining, utilizing a first machine learning model that takes as input at least a portion of a first data structure characterizing the index data associated with the usage of the one or more indexes in the one or more distributed systems, at least one additional index to be created in the one or more distributed systems and a predicted size of the at least one additional index;
determining, utilizing a second machine learning model that takes as input at least a portion of a second data structure characterizing the performance data associated with the one or more distributed systems, a load factor threshold for the one or more distributed systems;
predicting resource requirements associated with creation of the at least one additional index in the one or more distributed systems based at least in part on the predicted size of the at least one additional index;
controlling creation of the at least one additional index in the one or more distributed systems based at least in part on (i) the predicted resource requirements associated with the creation of the at least one additional index in the one or more distributed systems and (ii) determining whether a current workload of the one or more distributed systems exceeds the determined load factor threshold for the one or more distributed systems; and
responsive to determining that the creation of the at least one additional index in the one or more distributed systems is completed, monitoring usage of the created at least one additional index in the one or more distributed systems and determining whether to retain the created at least one additional index in the one or more distributed systems based at least in part on the monitored usage of the created at least one additional index;
wherein the method is performed by at least one processing device comprising a processor coupled to a memory.

19. The method of claim 18 wherein controlling the creation of the at least one additional index in the one or more distributed systems comprises:
initiating, responsive to detecting that the one or more distributed systems have sufficient available resources according to the determined load factor threshold, an index creation job in the one or more distributed systems to create the at least one additional index;
pausing the index creation job responsive to detecting that the index creation job is currently running and that the one or more distributed systems do not have sufficient available resources according to the determined load factor threshold; and
resuming the index creation job responsive to detecting that the index creation job is paused and the one or more distributed systems have sufficient available resources according to the determined load factor threshold.

20. (canceled)

21. The computer program product of claim 15 wherein the program code when executed by the at least one processing device further causes the at least one processing device, responsive to determining that the creation of the at least one additional index in the one or more distributed systems is completed, to validate the created at least one additional index based at least in part on comparing a size of the created at least one additional index to the predicted size of the at least one additional index.

22. The method of claim 18 further comprising, responsive to determining that the creation of the at least one additional index in the one or more distributed systems is completed, validating the created at least one additional index based at least in part on comparing a size of the created at least one additional index to the predicted size of the at least one additional index.

23. The apparatus of claim 1 wherein predicting the resource requirements associated with creation of the at least one additional index in the one or more distributed systems is further based at least in part on the index data associated with the usage of the one or more indexes in the one or more distributed systems.

24. The apparatus of claim 1 wherein predicting the resource requirements associated with creation of the at least one additional index in the one or more distributed systems is further based at least in part on training of the first machine learning model.

25. The apparatus of claim 24 wherein the first machine learning model is trained based at least in part on information characterizing a collection size, an average object size and an index field size for the at least one additional index.
